(19) United States
(12) Patent Application Publication
(10) Pub. No.: US 2012/0016594 A1
(43) Pub. Date: Jan. 19, 2012

(54) METHOD FOR TRANSLATING GENETIC INFORMATION FOR USE IN PHARMACOGENOMIC MOLECULAR DIAGNOSTICS AND PERSONALIZED MEDICINE RESEARCH

(75) Inventors: Michael F. Christman, Philadelphia, PA (US); Margaret A. Keller, Pitman, NJ (US); Neda Gharani, Highland Park, NJ (US); Erynn Gordon-Fishman, Mount Laurel, NJ (US); Catharine B. Stack, Glenmoore, PA (US)

(73) Assignee: CORIELL INSTITUTE FOR MEDICAL RESEARCH, INC., Camden, NJ (US)

(21) Appl. No.: 13/175,178

(22) Filed: Jul. 1, 2011

Related U.S. Application Data
(60) Provisional application No. 61/360,963, filed on Jul. 2, 2010.

(51) Int. Cl. G06F 19/10; G06F 19/28

(52) U.S. Cl. 702/19

(57) ABSTRACT

A gene-drug specific system for classifying individual genetic variants based on strength-of-evidence of clinical utility from published scientific and clinical data that support their effect on modifying drug response and behavior. This allows categorization of the genetic variants into evidence classes that have a wide range of uses such as pharmacogenomic molecular diagnostics and personalized medicine research designed to guide the clinical implementation of PGx. Furthermore, this information can be combined with a knowledgebase of drug-response phenotypes, a knowlegebase of specific drug-induced outcomes and individual patient diplotype information for a gene-drug combination into a programmed computer to output corresponding patient-specific predicted drug responses.

### CROSS REFERENCE TO RELATED APPLICATION(S)

This application claims the benefit of U.S. Provisional Application No. 61/360,963, filed Jul. 2, 2010.

### FIELD OF THE INVENTION

The present invention relates in general to personalized medical research and in particular to a method for quantifying the strength-of-evidence of a data source related to a gene variation and the corresponding clinical utility of the gene variant as a marker for drug response.

### BACKGROUND OF THE INVENTION

The invention pertains generally to the field of pharmacogenomics (PGx). PGx is the study of both the different genes that determine drug response as well as the genetic variations that play a role in response to drugs, vaccines, and pharmaceutical agents. Genetic variations in several drug-metabolizing enzyme and transporter genes can contribute to considerable individual variation in drug disposition and response. This variation in response to prescribed drugs is a serious clinical problem contributing to the prevalence of adverse drug reactions (ADRs). Because of the high costs (in both suffering and dollars) associated with ADRs, it has been of increasing interest to integrate PGx into the management of personalized healthcare. Recent improvements in technology, including the human genome project, small nucleotide polymorphism (SNP)-based high-throughput genotyping platforms as well as a significant drop in the cost of genotyping, have all been key in making PGx a tangible tool in the advancement of personalized medicine. Given the clinical impact of pharmacogenetic variants, PGx has the potential to be one of the first areas for implementation of personalized medicine by improving drug efficacy and safety. However, despite the numerous examples showing a causative link between inherited genetic variations and substantial interindividual differences in drug effects, only a handful of pharmacogenetic variants have been translated into clinical diagnostic tests. This lag in implementation has partly been due to the lack of rigorous systems for translating the vast amount of clinical and scientific data, for specific drug-gene interactions, and filling in gaps in knowledge in a way that can be used by therapeutics and diagnostic developers and regulators to make meaningful risk-benefit assessment. In particular, translational research is required to set a high evidentiary standard in order to trigger investment by drug and diagnostic companies in a PGx discovery.

Although as many as 10% of labels for FDA-approved drugs contain pharmacogenomic information, the development of validated tests and the uptake by clinicians of the PGx information and diagnostic tools has been slow. The success of PGx integration in personalized medicine will depend on having accurate diagnostic tests that accurately identify patients who can benefit from the targeted therapies. This lag in translation of research findings to the clinic has in part been due to the need for a rigorous system for interpreting the complex knowledge that is accumulating.

The Pharmacogenomic Knowledge Base (PharmGKB, https://www.pharmgkb.org/index.jsp) is a web-based database of curated and annotated data on PGx gene variants and gene-drug-disease relationships that includes summaries of important PGx genes and drug pathways. A variety of information is gathered and presented. The most relevant to the invention is the listing of VIP PGx genes, https://www.pharmgkb.org/search/browseVip.action?browseKey=a nnotatedGenes, and listing of Clinical PGx, https://www.pharmgkb.org/clinical/index.jsp.

The VIP PGx link provides a list of important genes known to affect drug behavior and response. This site provides a summary of the gene function as it relates to drug metabolism and response. This includes an overview of genetic phenotypes and adverse drug reactions or reduced efficacy, a list of drug pathways affected by the gene, a listing of drugs/substrates/inhibitors/Inducers, as well as an incomplete listing of gene variants with variable annotation of supportive data.

The Clinical PGx link at PharmGKB is a list of drugs with pharmacogenomic information in the context of FDA-approved drug labels and lists drugs with mounting pharmacogenomic evidence. For each drug listed, PGx gene(s) and genetic variant information relating to the content of the FDA drug label is provided.

Other published studies that are relevant to the invention presented in this application include a recent publication that describes the clinical assessment of a single individual in the context of his full genome sequence (Ashley 2010). In this study, 63 clinically relevant previously described PGx variants were identified and summaries of the drug-related genotype-phenotype (drug response) associations relevant to the patient were curated and presented. Curation of data was carried out by PharmGKB curators who reviewed drug-related variant annotations for their clinical relevance to the patient. They assigned a level of evidence (High, Medium or Low) to each variant annotation based on a clinician's appraisal of the impact of the variant. This was based on the strength of results in the literature, the effect size of the phenotype, the availability of alternative drugs for treatment and included literature evidence for likelihood of favorable drug response, lack of efficacy, side effects, or dosing recommendation based upon the patients genotype.

Two additional groups have published papers that describe guidelines for evaluating PGx data and attempt to establish therapeutic recommendations:

1) The Royal Dutch Association for the Advancement of Pharmacy, which established the Pharmacogenetics Working Group with the objective of developing pharmacogenetics-based therapeutic (dose) recommendations, has published two papers that describe a system for evaluating PGx data (Swen 2008 and Swen 2011) involving a systematic review of published literature, scoring of evidence for drug phenotype or genotype categories and interpretation to therapeutic recommendations. Evidence scoring is based on level of evidence (based on study design) and clinical relevance (based on clinical or PK effects).

2) The second Group is the Clinical Pharmacogenetics Implementation Consortium (CPIC) whose goal is to provide peer-reviewed, evidence-based guidelines for gene/drug pairs. CPIC has adopted a similar approach to the Royal Dutch Association group described above. A systematic review of published data is followed by evidence rating based on quality of evidence and strength of recommendation (Relling 2011).

Additionally, U.S. Pat. No. 7,461,006 discloses a method that creates and utilizes a database which correlates patient characteristics including, environmental and demographic factors (e.g., diet, age, sex, race, etc.), as well as genetic variant information to drugs and adverse events.

### SUMMARY OF THE INVENTION

According to the present invention, the foregoing and other objects and advantages are obtained by utilizing a system and method for quantifying the strength-of-evidence of a data source related to a gene variation and the corresponding clinical utility of the gene variant as a marker for drug response.

The present invention is intended to provide a method of data curation and translation that simultaneously identifies genetic variants with clinical utility (thereby having actionable use in medical treatment), from those that require further clinical study, but are potentially actionable, from those that require further substantial basic scientific and clinical study (since the potential action of a gene variant on a drug is either unknown or unsupported at the present time).

It is an advantage of the present invention to provide a systematic, unbiased and comprehensive curation of published peer-reviewed scientific literature, peer-reviewed clinical literature, public web-based databases and other data sources regularly consulted by persons in the art for information related to gene-drug relationships. The system of the present invention allows coding of specific genetic variants based on strength-of-evidence of clinical utility to 14 Evidence Code categories and three Evidence Classes.

The evidence classes of the present invention differentiate between gene variants whose action is supported by clinical outcomes data (Class I); from those gene variants with in vivo or in vitro data that support a measurable difference in the response to the drug along with molecular evidence for effect of the mutation on protein function (Class II); from gene variants with in vitro or in vivo data supporting a difference in response to another drug only, those lacking supportive data for any drug and those that appear to be private (very rare) mutations with limited data on function (Class III). The comprehensive knowledgebase for a specific gene-drug pair can be updated as additional data sources become available.

According to one aspect of the invention, the method involves collecting data sources with information relevant to the combination of a particular gene variant and a particular reference drug. Next, each of the data sources are first placed in a category comprising clinical outcome studies; pharmacokinetic and pharmacodynamic studies; molecular and cellular functional studies; and genetic variation screening studies.

Next, each genetic variant is assigned the lowest numbered applicable evidence code based on the type of supporting data source comprising a first evidence code for a data source with in vivo clinical outcome studies for a reference drug, a second evidence code for in vivo pharmacokinetic or pharmacodynamic studies for a reference drug, a third evidence code for in vitro enzyme activity for a reference drug, a fourth evidence code for in vitro enzyme activity with a probe substrate with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a fifth evidence code for in vivo clinical outcome with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a sixth evidence code for in vivo pharmacokinetic or pharmacodynamic studies for a another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a seventh evidence code for in vitro enzyme activity with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, an eighth evidence code for in vitro enzyme activity with a probe substrate only, a ninth evidence code for in vivo clinical outcome with another drug only, a tenth evidence code for in vivo pharmacokinetic or pharmacodynamic studies for another drug only, an eleventh evidence code for in vitro enzyme functional studies only, a twelfth evidence code for in vitro or in vivo data studies that do not support a functional role, a thirteenth evidence code for circumstances where there is no in vitro or in vivo data and a fourteenth evidence code for genotype frequency data suggestive of a private mutation.

Next, the first evidence code is classified into evidence class I, the second through seventh evidence codes are classified into evidence class II and the eighth through fourteenth evidence codes are classified into evidence class III.

According to this embodiment of the invention, at least one knowledgebase is formed by collecting data sources with information relevant to the combination of individual gene variants for a particular gene and a particular reference drug.

Lastly, as new data sources become available, the process is repeated with the new data source and the knowledgebase is updated.

According to another embodiment of the invention, a database is formed that is a computer-implemented method for providing a computer user with data sources for all possible patient diplotypes (all pairwise combinations of the genetic variants classified as Class I or Class II) each with a link to the corresponding predicted drug response phenotype (specific drug-induced outcome).

Next, the at least one said knowledgebase and database are applied to a computer.

Next, a computer is used to produce the data source, drug response phenotype and/or drug induced outcome information corresponding to a particular patient's diplotype.

Lastly, this process is repeated as additional data sources, drug-response phenotypes and specific drug induced outcomes become known.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a diagram describing a method for carrying out one embodiment of the invention.

FIG. 2 is a chart exemplifying the results obtained by carrying out one embodiment of the invention; and

FIG. 3 is a diagram describing a system for carrying out one embodiment of the invention.

### DETAILED DESCRIPTION OF THE INVENTION

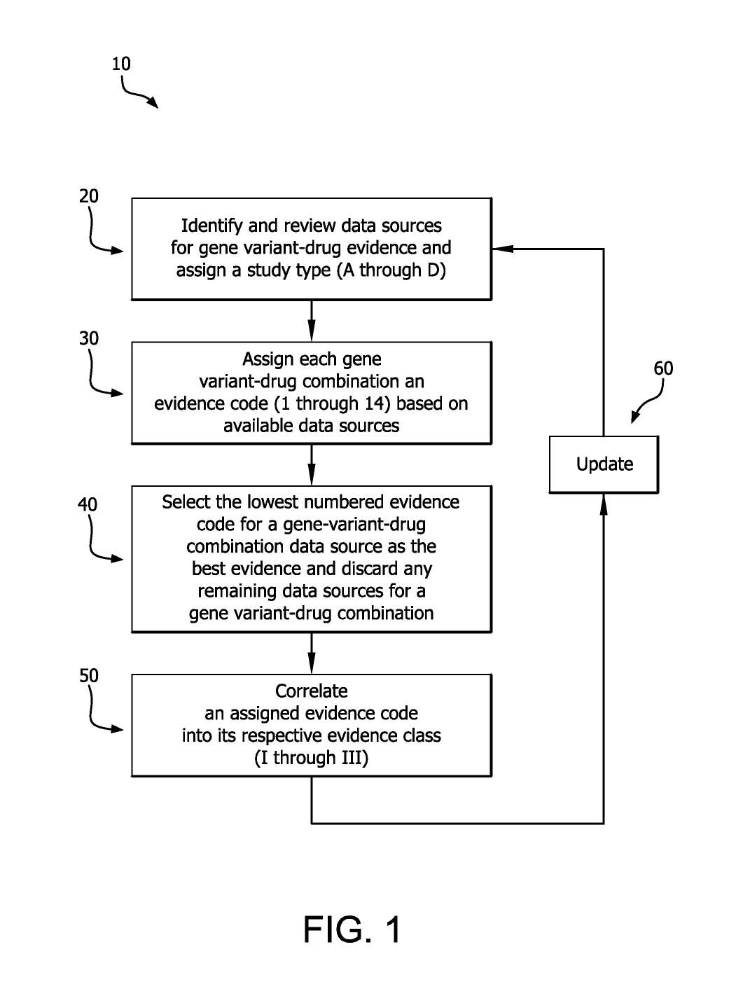

Referring to the drawings wherein like or similar references indicate like or similar elements throughout the several views, there is shown in FIG. 1 a diagram describing the method for carrying out one embodiment of the invention, generally identified by reference numeral 10.

Step 20 initiates the process according to the invention for a given drug of interest by identifying the gene(s) known to affect drug response and behavior. On-going review of published literature and web-based databases will identify genes in which specific genetic variants are shown to affect response to the drug of interest.

For each drug-gene pair, peer-reviewed scientific and clinical literature and public web-based databases are searched for studies that report drug-related genotype-phenotype associations. Searches include but are not limited to: (a) the drug of interest and “genetics”, (b) the drug and the gene of interest; (c) individual genetic variants or haplotypes of the gene of interest or the commonly used PGx star nomenclature for the variations in the gene. In addition, PGx specific databases including but not limited to PharmGKB, the Cytochrome P450 Allele Nomenclature Committee web site and other similar PGx gene specific databases are reviewed for information on lists of identified genetic variations and their drug phenotype association.

Publications gathered for each identified genetic variation are then reviewed to assess the strength-of-evidence of the genotype-phenotype association and the clinical utility of the variant as a marker for drug response.

Scientific and clinical studies can be categorized into the following types:

A. Clinical Outcomes studies—these demonstrate measurable difference in clinical endpoints such as side effects, rate of cure, morbidity, and mortality. These studies demonstrate that the genetic variant significantly changes the medical outcome in response to the administered drug.
B. Pharmacokinetic (PK) and Pharmacodynamic (PD) studies—PK studies examine the effect of the genetic variant on the absorption or distribution or metabolism or elimination of the drug. In these studies the genetic variant is associated with variability in the level or concentration of the drug and its metabolites at the site of action. PD studies examine genetic variants in the drug targets that show a measurable difference in the biomarker's response to the drug. Although the measured variables (biomarkers) may be considered as surrogates for a clinical response they are not translated directly to clinical outcomes as the effect on clinical outcomes may be insufficiently significant to alter practice or policy.
C. Molecular and cellular functional studies—These examine how the genetic variant alters the function of the enzyme or protein or the whole cell by in vitro functional assays. For example the effect of the variant on enzyme kinetics, gene activation and expression or cellular properties of the cells involved in the response to a drug may be measured and assessed.
D. Genetic variation screening studies—These include studies in which the PGx gene variant was identified through DNA sequencing analysis either in control or patient populations, without any additional functional or clinical studies to support a functional role in for the variant.

Step 30 assigns each gene variant an Evidence Code based upon the strength-of-evidence of clinical utility for the genetic variant based on the supporting published study data source (categorized as type A through D in step 20). The Evidence Code is a score of 1 to 14 (as shown below in Table 1). The evidence codes are defined as follows:

Evidence Code 1—This is a category A study looking directly at the effect of the genetic variant on the drug of interest.

Evidence Code 2—This is a category B study looking directly at the effect of the genetic variant on the drug of interest.

Evidence Code 3—This is a category C study looking directly at the effect of the genetic variant on the drug of interest.

Evidence Code 4—This is a category C study looking at the effect of the genetic variant on a probe drug (industry standard substrate used for evaluating enzyme function) and includes analysis of the mutation type based on 4 categories: null (abolishes function), potentially affects substrate binding or catalytic activity or located in highly evolutionary conserved residue, results in a splicing error (this can reduce or abolish function), results on altered gene expression (this can reduce or increase protein function), results in accelerated degradation of protein or mRNA (this can reduce or abolish function), or is a result of gene duplication.

Evidence Code 5—This is a category A study looking at the effect of the genetic variant on another drug and includes analysis of the mutation type based (as specified above).

Evidence Code 6—This is a category B study looking at the effect of the genetic variant on another drug and includes analysis of the mutation type based (as specified above).

Evidence Code 7—This is a category C study looking at the effect of the genetic variant on another drug and includes analysis of the mutation type based (as specified above).

Evidence Code 8—This is a category C study looking at the effect of the genetic variant on a probe drug only.

Evidence Code 9—This is a category A study looking at the effect of the genetic variant on another drug only.

Evidence Code 10—This is a category B study looking at the effect of the genetic variant another drug only.

Evidence Code 11—This is a category C study looking at the effect of the genetic variant another drug only.

Evidence Code 12—This is a category A-C study that demonstrates no effect of the genetic variant on drug behavior or response.

Evidence Code 13—This is a category D study (i.e. identified through sequencing but no additional functional or drug phenotype data available).

Evidence Code 14—Genotype frequency data is suggestive of a “private mutation” defined as a genetic variant found in a single individual or single family without being observed in reference populations.

Step 40 requires the data source reflecting greatest strength-of-evidence for clinical utility for a gene variant-drug combination to be selected from among all of the available data sources for a gene variant-drug combination, thereby discarding any data sources for a gene variant-drug combination reflecting weaker evidence. The selected data source is designated as the best evidence for the clinical utility for a gene variant-drug combination. Based on the stratification of Evidence Codes, the lower numbered evidence codes correlate to stronger evidence.

Evidence Codes are then translated into Evidence Classes in Step 50 (I through III, as reflected in Table 1 below) that can provide utility for clinical diagnostic and research purposes. Evidence Class I includes variants with Evidence Code 1 only and identifies variants that are clinically relevant (actionable); Evidence Class II groups Evidence Codes 2 to 7 defined as those that lack clinical outcomes data but for whom there is a measurable difference in drug response (potentially actionable); and Evidence Class III identifies variants with Evidence Codes 8-14, that either affect response to another drug only, or lack supportive data for response to any drug or include those that appear to be private (very rare) mutations with limited data on function or action on drug response.

Evidence Classes can then be used for a variety of purposes such as guiding the use of clinical diagnostics tools (Class I), the design of personalized medicine research studies (Class I and Class II) and identify gaps in knowledge for further basic scientific and clinical research (Class II and III).

The relationship between Evidence Codes and Evidence Classes is depicted as follows as Table 1:

TABLE 1

| | Evidence | Evidence |
|---|---|---|
| Evidence type | code | Class |
| In vivo clinical outcome for reference drug | 1 | I |
| In vivo PK/PD for reference drug | 2 | II |
| In vitro enzyme activity for reference drug | 3 | II |
| In vitro enzyme activity with probe substrate | 4n or 4scd or | II |
| plus mutation type (n, scd, se, ae) | 4se or 4ae or | |
| | 4ad or 4dp | |
| In vivo clinical outcome with another drug | 5n or 5scd or | II |
| plus mutation type (n, scd, se, ae) | 5se or 5ae or | |
| | 5ad or 5dp | |
| In vivo PK/PD for another drug plus mutation | 6n or 6scd or | II |
| type (n, scd, se, ae) | 6se or 6ae or | |
| | 6ad or 6dp | |
| In vitro enzyme activity with another drug | 7n or 7scd or | II |
| plus mutation type (n, scd, se, ae) | 7se or 7ae or | |
| | 7ad or 7dp | |
| In vitro enzyme activity with probe substrate | 8 | III |
| only | | |
| In vivo clinical outcome with another drug | 9 | III |
| only | | |
| In vivo PK/PD for another drug only | 10 | III |
| In vitro enzyme functional (protein stability | 11 | III |
| or enzyme activity with another drug) only | | |
| In vitro or in vivo data does not support | 12 | III |
| functional role | | |
| No in vitro or in vivo data | 13 | III |
| Genotype frequency data suggestive of | 14 | III |
| “private mutation”. | | |

PK = pharmacokinetic;
PD = pharmacodynamic;
n = null mutation;
scd = mutation located in known important substrate-binding or catalytic domain;
se = mutation leading to splicing error;
ae = mutation leading to altered gene expression,
ad = results in accelerated degredation of protein or mRNA (this can reduce or abolish function), or
dp = is a result of gene duplication.
Note for genetic variants with multiple evidence types the lower evidence code number is assigned (i.e. greatest strength-of-evidence).

Step 60 provides for the update for a gene-drug specific knowledgebase as additional scientific and clinical data become available. In such an instance, any newly available data source would iterate through the above-stated process in order to determine whether the new data source offers any superior evidence than the currently assigned evidence code for a gene variant-drug combination data source. If so, the new data source would become the best evidence for a gene variant-drug combination and the prior best evidence would be discarded.

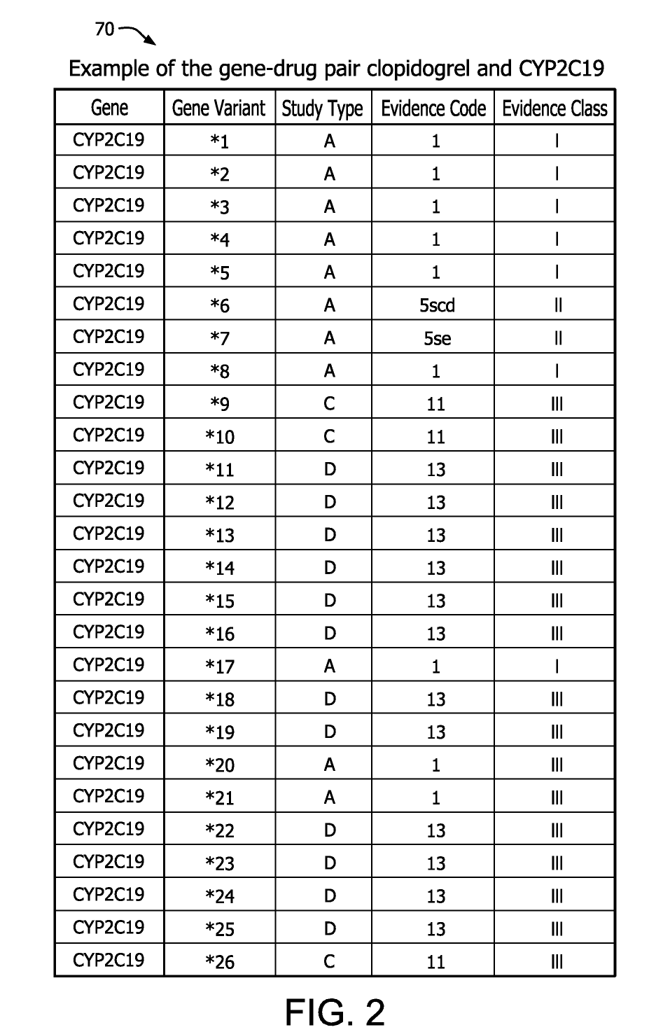

Turning to FIG. 2, there is a chart exemplifying the result obtained by carrying out one embodiment of the present invention, generally identified by reference numeral 70. Chart 70 provides an example of the classification of data sources for twenty-six (26) gene variants for the gene CYP2C19 for interaction with the specific drug clopidogrel according to one embodiment of the present invention.

Clopidogrel is an anti-platelet medication used to reduce risk of atherosclerotic events (stroke, myocardial infarction (MI), and vascular death) by inhibiting the formation of blood clots in patients with acute coronary syndrome, recent MI, recent stroke, established peripheral arterial disease. Inhibition of platelet aggregation by clopidogrel can vary considerably between patients, with 20-400 of patients being classified as non-responders, poor-responders or resistant to clopidogrel because of low inhibition of ADP-induced platelet aggregation or activation. Suboptimal platelet inhibition is associated with increased risk of subsequent cardiovascular events. A number of studies have identified the gene encoding CYP2C19 as a PGx gene that consistently shows association with primary clinical outcomes in patient populations. There are at least 26 variant forms of CYP2C19 described (http://www.cypalleles.ki.se/cyp2c19.htm; as of 6/18/10). Of these variants CYP2C19*1, CYP2C19*2, CYP2C19*3, CYP2C19*4, CYP2C19*5, CYP2C19*8 and CYP2C19*17 have clinical outcomes data available and are all assigned Evidence Code “1”. CYP2C19*6 and CYP2C19*7 are assigned Evidence Code “5scd” and “5se” respectively since the highest evidence available is clinical evidence for another drug along with molecular data that supports effect on enzyme function. CYP2C19*9, CYP2C19*10 and CYP2C19*26 are assigned Evidence Code “11” since the highest evidence is for molecular functional study with another drug. Variants CYP2C19*11-CYP2C19*16, CYP2C19*18, CYP2C19*19 and CYP2C19*22-CYP2C19*25 all have Evidence Code “13” since they lack clinical or molecular functional data and were identified through gene sequencing studies. CYP2C19*20 and CYP2C19*21 are polymorphic subtypes of CYP2C19*3 and CYP2C19*2 respectively, and are not functionally distinct variants. After assigning the proper evidence codes in chart 70, the corresponding Study Type and Evidence Class for each gene variant can be derived according to the process described in the above stated embodiment. Further research and clinical resources could be allocated based on the outcome reflected in chart 70 as follows: CYP2C19*1-5, *8 and *17 (Evidence Code “1”—Class I variants) are currently supported for clinical assessments, CYP2C19*6 and *7 would be added to the above list for use in personalized medicine research (Class II variants) and the rest of the variants either require further study or are not functionally relevant (Class III variants).

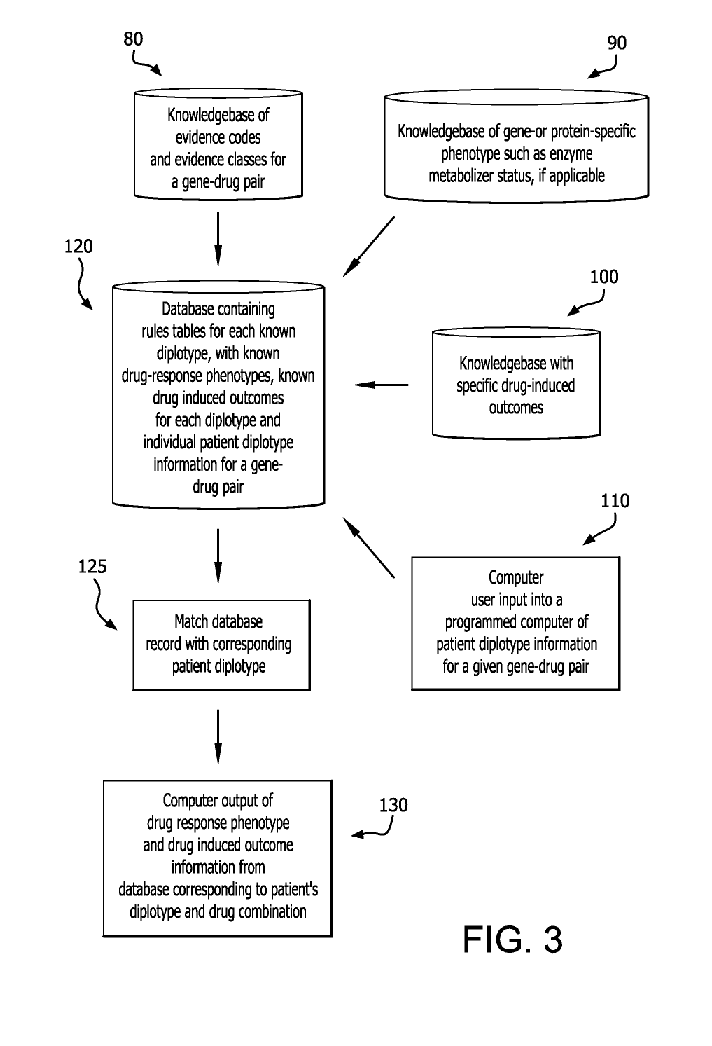

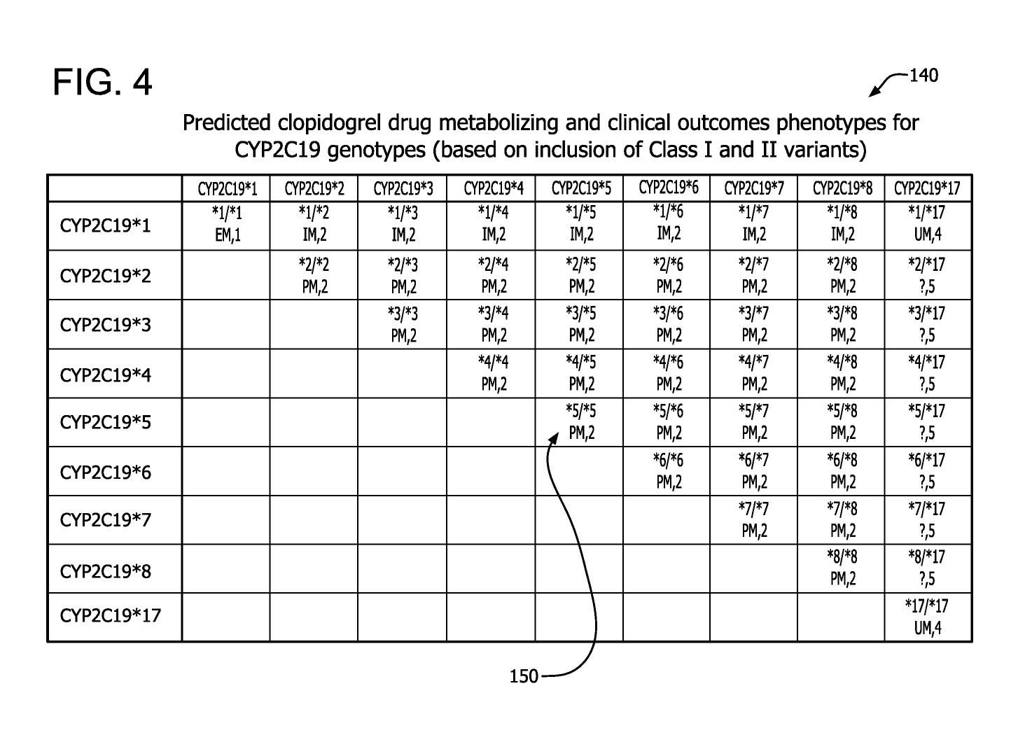

In another embodiment of the invention depicted in FIG. 3, evidence codes and evidence classes 80 are then used to translate individual genetic results 110 (based on potential diploid combinations of the relevant genetic variants) into predicted drug response phenotypes 130 (as depicted in the simple punnett square of drug response phenotypes in Table 2 below). Once drug-specific rules are established 120, this translation process 125 is implemented into computerized programs for the interpretation of an individual's genetic test results 130. This process is useful for research and health care professionals to guide clinical practice.

Evidence codes and evidence classes allow selection of the genetic variants to be included in the rules tables within a database 120 (this is utility specific in that class I variants are for diagnostic application; and class I and II are for personalized medicine research application). The punnett square table provides the drug-gene pair specific rules for genetic results interpretation. If published guidelines are available based on empirical data or published clinical outcome data, these will be used to classify diplotypes to specific drug response phenotype groups 90 (e.g. for drug metabolizing enzyme: ultra-rapid metabolizers (UM), extensive metabolizers (EM), intermediate metabolizer (IM), poor metabolizers (PM), etc.) and/or specific drug-induced outcomes, such as adverse drug reaction or reduced efficacy 100. In some cases, there may be a lack of published data for a specified diplotype, thus, the predicated phenotype will be unknown. By pairing all variants included for the application, in all possible two-way combinations representing distinct diploid individuals, a list of potential diplotypes is created, each with a drug-specific drug-response phenotype interpretation 120.

The simple punnett square shown below in Table 2 provides the general rules used to assign variant-based phenotypes to diplotype-based phenotypes. The rules table provides gene or protein specific as well as clinical outcome specific summary for each potential diplotype. For example, for a drug metabolizing enzyme, both the defined metabolizer type (e.g. EM, IM, PM, UM or ? to specify unknown phenotype) will be indicated as well as the association with a specific drug induced outcome 100 (adverse event or reduced efficacy). In the example punnett square depicted below in Table 2, a number, separated by a comma, follows the metabolizer type abbreviation where the numbers are defined as follows: the number “1” defines “normal response” to the drug, number “2” defines “most extreme adverse reaction or altered efficacy” resulting from deficiency of the PGx protein product, if applicable, number “3” is used to define “a clinically distinct or milder adverse drug reaction/altered efficacy” resulting from protein deficiency, number “4” defines a “distinct adverse reaction or altered efficacy” resulting from excess or increased protein product; and number “5” represents “unknown phenotype” for the defined diplotype. Additional numbers may be added to define further distinct phenotypes. In this way, rules that determine the number coding for a single gene (e.g. CYP2D6) may be different in the context of different drug pairs (e.g. CYP2D6 and tamoxifen versus CYP2D6 and codeine). These general rules are then used to derive the drug-gene specific algorithm for translating genetic test results based on all combinations of variants included in the database 120. The algorithm operates by selecting the gene or protein-specific phenotype and drug-induced outcomes that may exist from the database of all possible patient diplotypes that correspond to an individual patient's diplotype 125. This translation process can then be implemented into an automated program for interpretation of genetic test results 130.

TABLE 2
An example of a Simple Punnett Square showing the
rules for assignment of predicted drug metabolism
phenotype for a particular PGx Gene

| Metabolic | | | |
|---|---|---|---|
| phenotype of | | Genetic | |
| specific genetic | Genetic | variant | Genetic |
| variants with | variant with | with | variant with |
| evidence | Normal | Reduced | Enhanced |
| class I or II | Activity | Activity | activity |
| Genetic variant | EM, 1 | IM, 3 | UM, 4 |
| with Normal | | | |
| Activity | | | |
| Genetic variant | | PM, 2 | Unknown, 5 |
| with Reduced | | | |
| Activity | | | |
| Genetic variant | | | UM, 4 |
| with Enhanced | | | |
| activity | | | |

FIG. 4, generally identified by reference numeral 140, depicts the phenotype translation table for Clopidogrel-CYP2C19 for a personalized medicine research application (includes variants classified with evidence Class I and II). The diplotype-specific rules presented in FIG. 4 are used to develop a genetics results interpretation algorithm which is implemented on a computerized program. Input to the computer program from a patient includes gene specific information that is used to determine the predicted drug-specific response phenotypes.

Each potential CYP2C19 genotype is assigned a predicted drug metabolizing phenotype based on predicted metabolic activity of individual variants (normal, enhanced or reduced enzymatic function) such that extensive metabolizer (EM) is defined as 2 alleles with normal activity; ultra rapid metabolizers (UM) with 2 enhanced activity alleles or 1 normal and 1 enhanced allele; Intermediate metabolizers (IM) have 1 normal and 1 poor metabolizing allele; and Poor metabolizers (PM) have 2 reduced activity alleles. The drug metabolizing phenotype for the presence of 1 enhanced activity and 1 reduced activity alleles is currently uncertain and denoted by “?”. A number, separated by a comma, follows the metabolizer abbreviation, as identified, for example, in reference number 150, and is used to define expected drug response based on published outcomes data such that: The Number “1” indicates likely normal response to clopidogrel; the number “2” indicates those at increased risk of ischemic events when taking clopidogrel; the number “4” represents an increased risk of bleeding, but are likely to derive greater protection from ischemic event while on clopidogrel. The number “5” indicates unknown phenotypic assignments.

Genotype-phenotype interpretation algorithms used in drug response phenotype interpretation databases are also updated with new information obtained, along with data sources.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A method for quantifying the strength-of-evidence of a data source related to a gene variation paired with a specific drug and the corresponding clinical utility of the gene variant as a marker for the said specific response, comprising the steps of:
collecting data sources with information relevant to the combination of a particular gene variant and a particular reference drug,
categorizing each said data source into a category comprising clinical outcome studies; pharmacokinetic and pharmacodynamic studies; molecular and cellular functional studies; and genetic variation screening studies,
assigning each said genetic variant into the lowest numbered applicable evidence code based on the type of supporting data source where said evidence codes comprise a first evidence code for in vivo clinical outcome studies for a reference drug, a second evidence code for in vivo pharmacokinetic or pharmacodynamic studies for a reference drug, a third evidence code for in vitro enzyme activity for a reference drug, a fourth evidence code for in vitro enzyme activity with a probe substrate with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a fifth evidence code for in vivo clinical outcome with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a sixth evidence code for in vivo pharmacokinetic or pharmacodynamic studies for a another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a seventh evidence code for in vitro enzyme activity with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, an eighth evidence code for in vitro enzyme activity with a probe substrate only, a ninth evidence code for in vivo clinical outcome with another drug only, a tenth evidence code for in vivo pharmacokinetic or pharmacodynamic studies for another drug only, an eleventh evidence code for in vitro enzyme functional studies only, a twelfth evidence code for in vitro or in vivo data studies that do not support a functional role, a thirteenth evidence code for circumstances where there is no in vitro or in vivo data and a fourteenth evidence code for genotype frequency data suggestive of a private mutation, classifying said first evidence code into evidence class I, classifying said second through seventh evidence codes into evidence class II and classifying said eighth through fourteenth evidence codes into evidence class III; and
repeating the process as additional data sources become known.

2. A computer-implemented method for providing a computer user with data sources and knowledge-bases associated with a particular patient diplotype-drug pair selected from all possible diplotypes corresponding to a given gene variant-drug pair, comprising the steps of:
creating at least one first knowledge-base by collecting said data sources with information relevant to the combination of a particular gene variant and a particular reference drug,
creating at least one second knowledge-base by eliciting information from said computer user to assign each said gene variant into the lowest numbered applicable evidence code based on the type of supporting said date source were said evidence codes comprise a first evidence code for in vivo clinical outcome studies for a reference drug, a second evidence code for in vivo pharmacokinetic or pharmacodynamic studies for a reference drug, a third evidence code for in vitro enzyme activity for a reference drug, a fourth evidence code for in vitro enzyme activity with a probe substrate with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a fifth evidence code for in vivo clinical outcome with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a sixth evidence code for in vivo pharmacokinetic or pharmacodynamic studies for a another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, a seventh evidence code for in vitro enzyme activity with another drug with a mutation type comprising a null mutation, mutation located in a known important substrate-binding or catalytic domain or located in highly evolutionarily conserved residue, a mutation leading to a splicing error, a mutation leading to altered gene expression, a mutation resulting in accelerated degradation of protein or mRNA, or the presence of a gene duplication, an eighth evidence code for in vitro enzyme activity with a probe substrate only, a ninth evidence code for in vivo clinical outcome with another drug only, a tenth evidence code for in vivo pharmacokinetic or pharmacodynamic studies for another drug only, an eleventh evidence code for in vitro enzyme functional studies only, a twelfth evidence code for in vitro or in vivo data studies that do not support a functional role, a thirteenth evidence code for circumstances where there is no in vitro or in vivo data and a fourteenth evidence code for genotype frequency data suggestive of a private mutation, classifying said first evidence code into evidence class I, classifying said second through seventh evidence codes into evidence class II and classifying said eighth through fourteenth evidence codes into evidence class III,
creating at least one third knowledge-base with information elicited by said computer user concerning said particular patient's gene diplotype for the given said gene variant-drug pair,
applying all said knowledge-bases to establish at least one computer database,
using said computer programmed to select the said data source corresponding to the said particular patient's diplotype and drug pair from the said at least one database, and
repeating the process as additional said data sources become known.

3. The method of claim 2 further comprising the step of categorizing each said data source within the said first knowledge-base into a category comprising clinical outcome studies; pharmacokinetic and pharmacodynamic studies; molecular and cellular functional studies; and genetic variation screening studies.

4. The method of claim 2 further comprising the step of limiting said data sources produced by said computer to those corresponding to one of said evidence classes selected by said computer user.

5. The method of claim 2 further comprising the steps of:
creating at least one knowledge-base of drug-response phenotypes for the known said diplotypes,
applying all said-knowledge bases to establish at least one computer database,
using said computer programmed to select the said data source and said drug-response phenotypes corresponding to a particular patient's diplotype and drug pair from the said at least one database, and
repeating the process as additional said data sources and drug-response phenotypes for the said diplotypes become known.

6. The method of claim 2 further comprising the steps of:
creating at least one knowledge-base of drug-induced outcomes for known said diplotypes,
applying all said knowledge-bases to establish at least one computer database,
using said computer programmed to select the said data source and said drug-induced outcomes for known diplotypes corresponding to a particular patient's diplotype and drug pair from the said at least one database,
repeating the process as additional said data sources and drug-induced outcomes for the said diplotypes become known.

7. The method of claim 2 further comprising the steps of:
creating at least one knowledge base of drug-response phenotypes and drug-induced outcomes for known said diplotypes,
applying all said knowledge-bases to establish at least one computer database,
using said computer programmed to select the said data source, said drug-response phenotypes and said drug-induced outcomes for known diplotypes corresponding to a particular patient's diplotype and drug pair from the said at least one database, and
repeating the process as additional said data sources, drug-response phenotypes for the said diplotypes, and drug-induced outcomes for the said diplotypes become known.
